(19) United States
(12) Patent Application Publication
(10) Pub. No.: US 2015/0081774 A1
(43) Pub. Date: Mar. 19, 2015

(54) SYSTEM AND METHOD FOR IMPLEMENTING AUGMENTED OBJECT MEMBERS FOR REMOTE PROCEDURE CALL

(71) Applicant: John Wason, New Windsor, NY (US)

(72) Inventor: John Wason, New Windsor, NY (US)

(21) Appl. No.: 14/485,222

(22) Filed: Sep. 12, 2014

Related U.S. Application Data
(60) Provisional application No. 61/877,366, filed on Sep. 13, 2013.

(51) Int. Cl. H04L 29/08

(52) U.S. Cl. CPC H04L 29/08099; H04L 67/10
USPC 709/203

(57) ABSTRACT

A communication method and system configured to facilitate integration of complex automation systems composed of disparate components that may run with different processes, are distributed over a network, or are embedded devices. The system/method allows for a client to rapidly access functionality exposed by a service within a client-service system employing a distributed application structure utilizing an augmented object-oriented model of multiple member types. The system/method allows interconnected nodes to communicate through message passing and remote procedure calling so as to reduce latency within a system composed of distributed resources.

### RELATED APPLICATION

This application claims benefit of priority under U.S. provisional application Ser. No. 61/877,366, filed on Sep. 13, 2013, which is incorporated by reference herein in its entirety.

### FIELD OF THE INVENTION

Embodiments are related to distributed, client-server based systems. Embodiments are further related to a system and method for dynamically providing a fully functional object-oriented interface for a variety of programming languages.

### BACKGROUND

Remote Procedure Call (RPC) is a computer implemented protocol for constructing distributed, client-server based applications by splitting functions between “client” tasks and “server” tasks performed by various computer resources that are organized into a network for communication with each other. RPC is premised on extending the notion of conventional or local procedure calling, so that the called procedure need not exist in the same address space as the calling procedure. The two processes may be on the same system, or they may be on different systems with a network connecting them. By using RPC, programmers of distributed applications may avoid the details of the interface with the network, thus making the client/server model of computing more powerful and user friendly. Networking applications that provide RCP functionality are fairly common and include CORBA, XML-RPC, COM, ActiveX, Java™ RMI, and .NET Remoting, to name a few. Most of these communication methods only provide function calls, properties, and sometimes service to client events, though Java™ RMI and .NET Remoting allow for object-oriented references and garbage collection. These communication methods are typically intended for business applications and, thus, are designed to handle non-time critical data transfers. Thus, a need exists for improved communication methods in systems requiring time critical data transfers.

### BRIEF DESCRIPTION OF THE FIGURES

FIG. 1 illustrates an exemplary client-server system;

FIG. 2 illustrates a message passing layer that may be utilized by the client-server system;

FIG. 3 illustrates an embodiment of the RPC layer that may overlay the message passing layer;

FIG. 4 illustrates a block diagram of a method of client-service communication via messaging and RPC layers; and

FIG. 5 illustrates object members and how they implement functionality within the client-server system.

### DETAILED DESCRIPTION

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Unnecessary detail of known functions and operations may be omitted from the current description so as not to obscure the present invention. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed embodiments provide for a unique communication architecture that may be used in systems containing distributed resources, such as sensors and actuators. Communication within these types of distributed systems can be challenging due to the variety of communication technologies and protocols used in the multitude of devices that may make up the system. Most currently available protocols are not typically supported across a large class of devices, software packages, and languages. This means it is often necessary to implement custom interface software which is time consuming and generally requires highly specialized programming. The disclosed architecture provides for implementation of a communication specification and reference libraries to achieve consistent, device and programming language neutral communication for a large class of devices while presenting a powerful interface that allows user software to ignore most of the communication specifics while remaining simple and compact enough to be easily extended to new devices or embedded systems. Another advantage of the disclosed embodiments is that it minimizes latency in systems where most, if not all, actions are critical in real-time and where specific a priori knowledge of the devices within the system may be unknown.

FIG. 1 illustrates an exemplary client-server system 10 composed of at least one client 12 and at least one service 14, in which disclosed embodiments may be implemented. Typically a client-server system 10 employs a distributed application structure that partitions tasks or workloads between the providers of a resource or service (i.e., server) and service requesters (i.e., clients). A service 14 may execute one or more server programs which share resources with the client 12 upon request from the client 12. The client 12 and service 14 may be separate hardware systems that communicate via a network 16, such as the internet, but it should be noted that the client 12 and service 14 may also reside on the same hardware system. Typical hardware systems in which the client 12 and service 14 may be implemented can also include components such as a processor, memory (e.g., random access memory (RAM), etc.), user input devices (e.g., keyboard, mouse, etc.), a graphical user interface and other components for data-processing, and user interaction where necessary. According to the exemplary embodiment depicted in FIG. 1, the client 12 and the server 14 are applications running on the respective hardware, wherein client 12 and server 14 exchange data via call messages and reply messages.

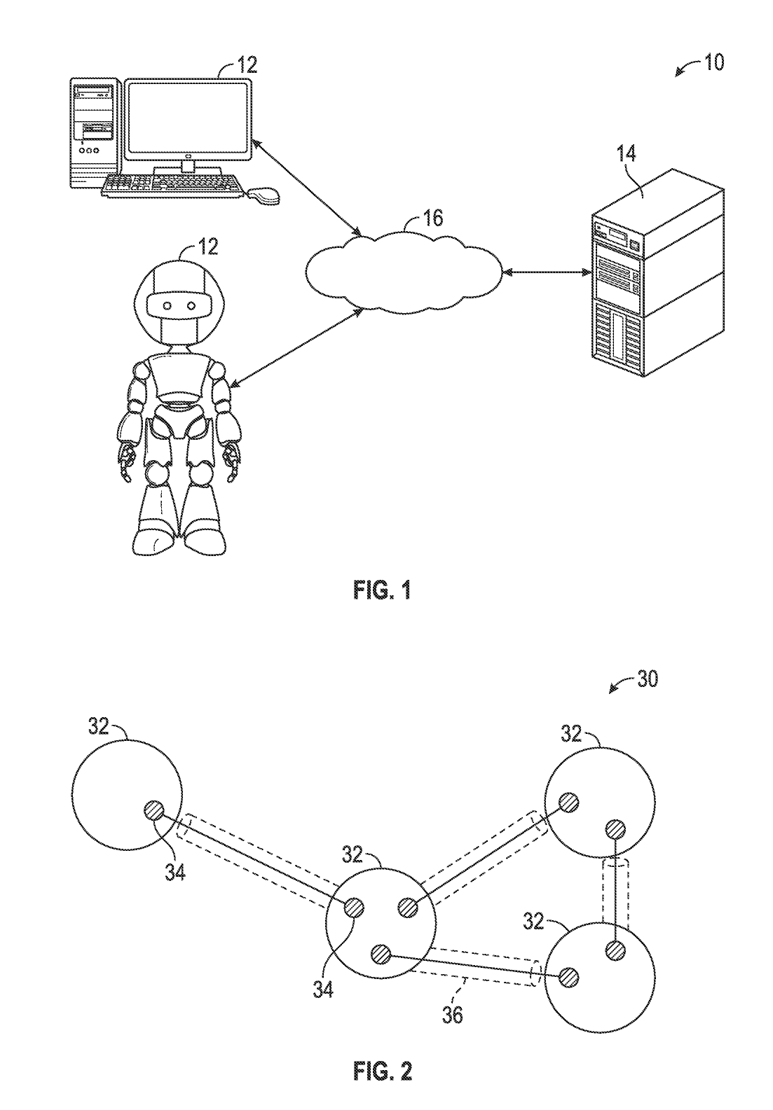

FIG. 2 illustrates a message passing layer 30 that may be utilized by the client-server system 10 described in FIG. 1. The layer 30 includes independent nodes 32, which are processes running on a computer or embedded device. These nodes can be critical real-time, non-critical real-time, or event driven processes. Each node 32 can include endpoints 34 that uniquely connect to an endpoint 34 in another node 32. The nodes 32 function by sending messages from a starting endpoint 34 in one node 32 to an end endpoint 34 in anther node 32 along a channel 36. The messages exchanged between nodes 32 contain routing information and data serialized in a specific format which is utilized by the nodes 32 to send the message through the correct channel 36.

Typical RPC methods provide either simple functions or an object-based system with object members. Object members consist of the contents of the object and implement functionality. Current RPC methods typically have three types of members: functions, properties, and events. The disclosed embodiments provide an improved method of RPC, which consists of the message passing layer 30 and an RPC layer 50. This RPC layer 50 specifies the precise types of data and objects that can be exposed by utilizing an augmented object-oriented model that has a number of member types, including: functions, properties, events objrefs, pipes, callbacks, wires, and memories, the functionalities of which are described below. The RPC layer 50 also utilizes value types, which are the data passed between a client and the service. Value types may be, but are not limited to, primitives, structures, maps, lists or multidimensional arrays.

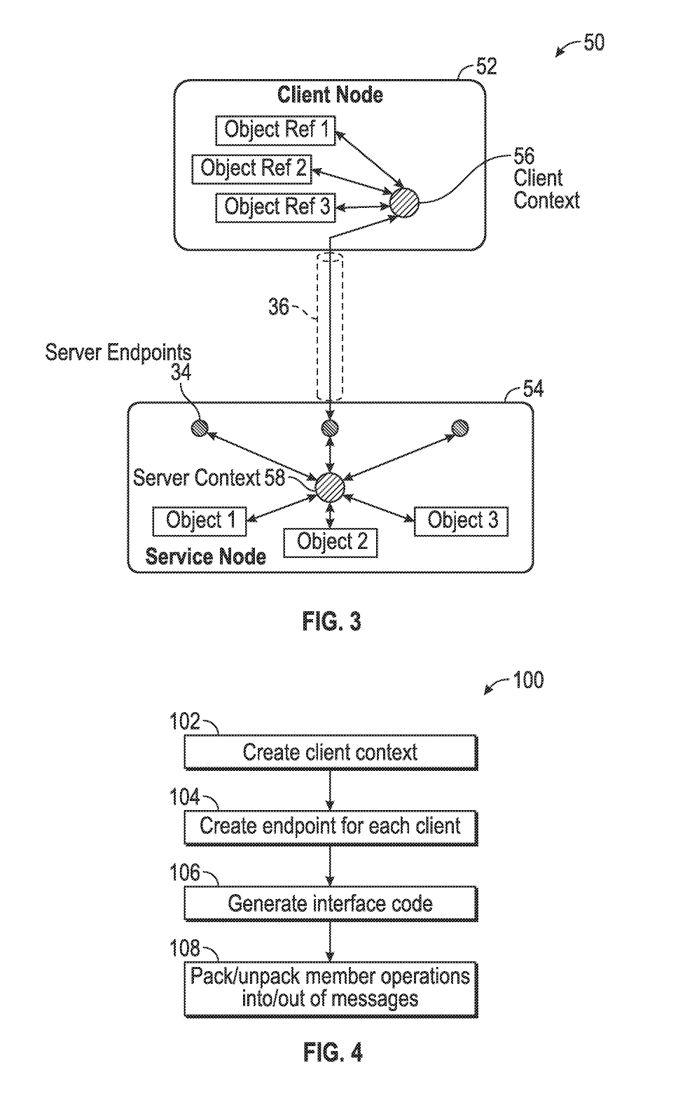

FIG. 3 illustrates an embodiment of the RPC layer 50 that may overlay the message passing layer 30. The RPC layer 50 is composed of a client node 52 (i.e., a node implemented on the client) and a service node 54 in communication via a channel 36. The client node 50 can contain a client context endpoint 56 which is created when the client 12 connects to the service 14. The client context endpoint 56 is utilized as a client-specific object reference and has the ability to find object references, process transaction requests for functions and properties, and dispatch events received from the service. The service node 54 may contain a service context 58 which manages an object and all its corresponding object references. The service node 54 may also contain endpoints 34 that are created for each client 12 connected to the service 14 as multiple clients 12 can be connected to a service context 58 at the same time. The endpoints 34 contained within the client 52 and service 54 nodes define connections between the nodes through channels, as depicted in FIG. 2.

FIG. 4 illustrates a block diagram of a method 100 of client-service communication via the messaging and RPC layers described in FIGS. 2 and 3, respectively. As shown in block 102, when a client connects to the service, an endpoint, also called a client context, is created within the client node which can be used for that client object reference. The service then creates an endpoint for each client connected to the service, as shown in block 104. In order to facilitate variation in member names and parameters between different types of objects, interface code is then automatically generated, as shown in block 106. This generated code takes member operations and parameters and packs or unpacks them into or out of messages being sent between client and service, as shown in block 108.

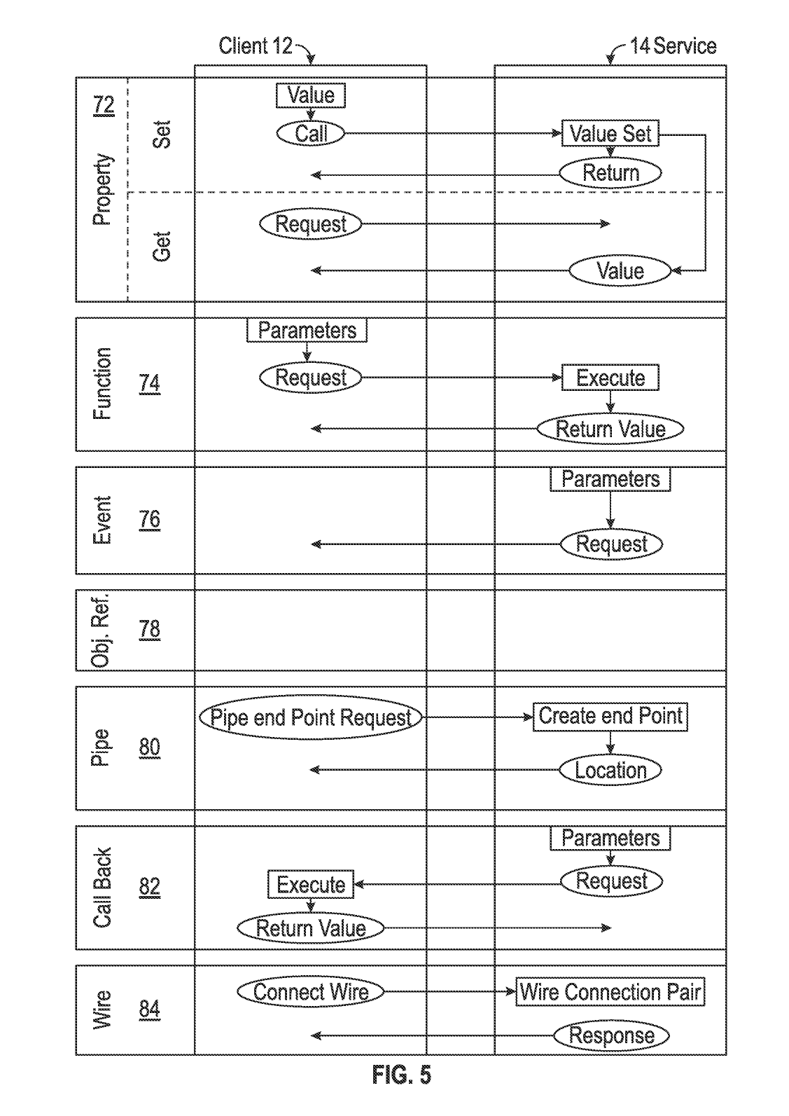

FIG. 5 illustrates object members and how they implement functionality within the client-server system 10. A “property” member 72 allows for the getting or setting of a variable value. During a set, the desired value is packed into a call message by the client 12 and sent to the service 14 where the value is set. A return packet with no data is sent to the client 12. During a get, the client 12 sends a request message to the service 14. The service 14 returns a reply message containing the current value of the property. During either get or set, an error may be returned.

A “function” member 74 allows a function with zero or more parameters to be called and returns zero or one return value. The client 12 packs the parameters into a function request message which is sent to the service 14. The service 14 executes the function and packs the return value type (if applicable) into a function response message which is sent to the client 12. An error may also be returned.

An “event” member 76 allows the service 14 to notify clients 12. Zero or more parameters are packed into an event request packet which is then sent to all clients 12 currently connected to the object containing the event. There is no error checking for the event.

An “object reference” (objref) member 78 is used to retrieve other objects within a service 14. A “service path” is used to address objects within a service 14. The objref 78 allows the client 12 to locate objects one level deeper in the path from the current object based on name and an optional index. The object reference 78 operates similar to a function, but returns an object reference instead of a value type

A “pipe” member 80 allows for transmitting packets either from client 12 to service 14 or from service 14 to client 12 in order. The pipe has at least four possible operations: “Connect”, “Close”, “SendPacket”, and “SendPacketAck”. The “Connect” operation is a transaction wherein the client 12 sends a connect request and the service 14 responds with a connected endpoint. A “PipeEndpoint” pair is created with one endpoint on the client 12 and one endpoint on the service 14. Endpoints created by a pipe member 80 are indexed. The “Close” operation deletes this pair and can be initiated by either the client 12 or the service 14. The “SendPacket” operation can be called by either endpoint and functions to enqueue the packet in the opposite endpoint's receive buffer. When an endpoint receives a packet, it can optionally generate a return packet using the “SendPacketAck” operation, which notifies the sender that the packet has been received. The “SendPacket” and “SendPacketAck” are not transactional and do not generate a return. The “SendPacketAck” operation is not called directly by the user, but is generated if the “SendPacketAck” option is set to “true” by the sending endpoint. The packets being transmitted are marked with a “RequestPacketAck” field that will cause the receiving endpoint to generate a “SendPacketAck”. This return packet is optional and is typically used to implement flow control.

The following is an example of a pipe member 80 operation. Pipe endpoint pairs are identified within a pipe 80 by client 12 and an index that allows multiple pairs between client 12 and service 14. To create a pipe 80, a pipe endpoint “Connect” request is sent by the client 12. The service 14 creates an endpoint and returns to the client 12 where the paired endpoint is created and returned. Or, alternatively, an error may be returned. The client 12 can send a “Close” request to the service 14 or the service 14 can send a “Close” request to the client 12. Data packets are sent as a message that contains address information, the client, the index, the packet number, and the data. The packet number allows the pipe endpoint to reconstruct the correct packet order.

A “callback” member 82 allows for the service 14 to execute a function on the client 12. It is essentially the same as the function member 74 in reverse. The client 12 specifies the function that handles this callback. On the service side, the service 14 requests the function reference for a specific client 12 and calls the function. The zero or more parameters are packaged into a message which is sent to the client 12. The client 12 executes the function and returns zero or more return values to the service 14 in a response message. An error may also be returned.

A “wire” member 84 provides the ability to communicate a constantly changing value where only the most recent value and the time the value was sent are important. It should be noted that a service 14 may have multiple wire connections to different clients 12, but unlike the pipe member 80, only one wire connection may be made per client 12. The wire member 80 is configured such that setting the “OutValue” of one endpoint causes the other's “InValue” to be updated, and vice-versa, resulting in the deletion of previous values or out of order values. A wire member 84 may be initiated when a client 12 requests a pair of endpoints be created by sending a connection request message to the service 14 where the connection is created. A response or error message may then be returned. A packet containing a value can then be sent either from client 12 to service 14 or from service 14 to client 12. For example, when the “OutValue” of one endpoint is set, a packet with a timestamp is generated and placed into the send queue for the transport layer. If that same “OutValue” is set again before it is actually transmitted, the newly generated packet will replace the old packet in the queue. This packet dropping behavior happens at the transport level so it may happen at a relay point, for instance if “Node A” sends a packet to “Node C” with “Node B” acting as a relay, “Node B” may discard outdated wire data packets. Eventually a packet will be transmitted to the other connection endpoint. At this point, the new packet will be compared to the timestamp on the current value. If the timestamp on the most recently received packet is newer, it will become the new “InValue” for the endpoint. If it is not newer, it will be discarded. In this way the wire provides a very efficient means for monitoring a constantly changing value such as the output of a sensor. Typically, these value packets do not generate returns and are not transactional. Either the client 12 or service 14 may close the wire connection.

A “memory” member 86 provides the client 12 the ability to read or write randomly accessible memory segments. The memory may either be a simple single dimensional array or a real/complex multi-dimensional array (not shown) within the client-server system 10. The memory reads the dimensions of the array and the complexity of the array (where applicable) by sending a request message with the requested parameter and the service returns a response message containing the requested value. The client 12 can also request the maximum memory transfer size in bytes in the same manner. When a read or write is executed, the operation is broken down into multiple “chunks” of data. A message is sent from the client 12 either requesting a read or sending a write, and the service 14 responds with an acknowledgement message or a message containing the requested data. An error may also be returned. The maximum data “chunk” size may be limited to the minimum of the maximum memory transfer size of the client 12 and service 14.

The embodiments disclosed herein may be employed to facilitate the integration of complex automation systems composed of disparate components as described in “Introduction to Robot Raconteur™ using Python” (Aug. 15, 2014) and “Robot Ranconteur A Communication Architecture and Library for Robotic and Automation Systems” by Dr. John Wason, both being incorporated by reference herein in their entirety.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for executing Remote Procedure Call comprising:
at least one client in operable communication with a server;
a message passing layer comprising endpoints, located at said at least one client and said server, connected by channels; and
an object-oriented Remote Procedure Call (RPC) layer.

2. The system of claim 1 wherein said RPC layer comprises a plurality of object members being executable by said at least one client and said server.

3. The system of claim 2 wherein one of said object members is a property member configured to get or set a variable value.

4. The system of claim 2 wherein one of said object members is a wire member configured to communicate a most recent value between said service and at least one client.

5. The system of claim 2 wherein one of said object members is a function member configured to allow a function of zero or more parameters to be called by said at least one client.

6. The system of claim 2 wherein one of said object members is an event member configured to allow said service to notify said at least one client.

7. The system of claim 2 wherein one of said object members is an object reference (objref) member configured to retrieve object references from said service.

8. The system of claim 2 wherein one of said object members is a pipe member configured to allow said at least one client to request a pipe endpoint be created with a matching endpoint in said service in order to send/receive packets between endpoints in order.

9. The system of claim 2 wherein one of said object members is a callback member configured to allow said service to execute a function on said at least one client.

10. The system of claim 2 wherein one of said object members is a memory member configured to allow said at least one client to read or write randomly accessible memory segments.

11. A method of client-server communication comprising:
creating an endpoint within a client node upon connection to a service;
creating an endpoint within a service for each client node connected to said service; and
generating interface code configured to pack and unpack parameters and object members into or out of packets sent between said client node endpoint and said service endpoint.

12. The method of claim 11 wherein said object members comprise at least one of a function member, an event member, an object reference member, a pipe member, a callback member, a wire member, and a memory member.

13. The method of claim 11 wherein said endpoints are created in response to executing a pipe member by transmitting a connect request from said client to said service allowing either endpoint to send or receive packets in order.

14. The method of claim 13 further comprising deleting said endpoints upon a close operation initiated by either said client or said service.

15. The method of claim 11 wherein said endpoints are created in response to executing a wire member by transmitting a connection request from said client to said service and generating a packet containing a value upon setting of an OutValue by either of said endpoints.

16. The method of claim 11 wherein executing said wire member further comprises:
sending said packet;
upon receipt of said packet containing said value, comparing a timestamp of said packet to a timestamp of a current value;
upon a determination that said timestamp of said packet is older than said timestamp of said current value, discarding said packet; and
upon a determination that said timestamp of said packet is newer than said timestamp of said current value, replacing said current value with said value contained in said packet.

17. The method of claim 11 further comprising executing a callback member wherein said service requests a function by transmitting a packet to said client and, upon receipt, said client executes said function and returns a resulting value to said service.

18. A method of client-server communication comprising:
in response to execution of an object member, creating an endpoint within a client node upon connection to a service;
in response to execution of an object member, creating an endpoint within a service for each client node connected to said service; and
generating interface code configured to pack and unpack parameters and object members into or out of packets sent between said client node endpoint and said service endpoint.

19. The method of claim 18 wherein said object members comprise at least one of a function member, an event member, an object reference member, a pipe member, a callback member, a wire member, and a memory member.

20. The method of claim 18 further comprising deleting said endpoints upon a close operation initiated by either said client or said service.
